(19) United States
(12) Patent Application Publication
(10) Pub. No.: US 2011/0255491 A1
(43) Pub. Date: Oct. 20, 2011

(54) METHOD AND APPRATATUS FOR RESOURCE ALLOCATION IN WIRELESS COMMUNICATION SYSTEM

(75) Inventors: Sungkwon HONG, Seoul (KR); Sung Jin SUH, Seoul (KR); Kyoung-min PARK, Goyang-si (KR)

(73) Assignee: PANTECH CO., LTD., Seoul (KR)

(21) Appl. No.: 13/087,958

(22) Filed: Apr. 15, 2011

(30) Foreign Application Priority Data
Apr. 15, 2010 (KR) 10-2010-0035021

(51) Int. Cl. H04W 72/04

(52) U.S. Cl. 370/329

(57) ABSTRACT

In a wireless communication system, a base station, a resource allocation device and method, a user equipment, a resource allocation reception device and method that utilize encoding and decoding techniques for transmitting through communication systems with uplinks and downlinks, the resource allocation information used to share transmission resources in a wireless communication system.

### CROSS-REFERENCE TO RELATED APPLICATION

This application claims priority from and the benefit under 35 U.S.C. §119(a) of Korean Patent Application No. 10-2010-0035021, filed on Apr. 15, 2010, which is hereby incorporated by reference for all purposes as if fully set forth herein.

### BACKGROUND

1. Field

This disclosure relates to resource allocation in a wireless communication system.

2. Discussion of the Background

In a wireless communication system, one of the basic principles in wireless access between a base terminal and various user terminals may be the transmission of a shared channel, such as the dynamic sharing of time-frequency resources between various user terminals. In order to facilitate this sharing, a base station may be utilized to control the allocation of resources for uplink and downlink.

### SUMMARY

Exemplary embodiments of the present invention provide an apparatus and a method for resource allocation in a wireless communication system.

Additional features of the invention will be set forth in the description which follows, and in part will be apparent from the description, or may be learned by practice of the invention.

In accordance with an aspect of the present invention, the present invention provides a base station, comprising: an encoder to generate single resource allocation information (r) by encoding a first coefficient sⁱⁿₖ (wherein, k=2*1, and 1 is an integer) and a second coefficient sⁱⁿₖ (wherein, k=2*1+1, and 1 is an integer), the first coefficient being obtained by converting a start index of one or more clusters including one or more resource blocks or resource block groups, the second coefficient sⁱⁿₖ being obtained by converting an end index of the one or more clusters; and a transmitter to transmit the resource allocation information (r) to a user equipment, wherein the resource allocation information is generated by the encoder using

$$r = {\sum }_{k = 0}^{{M}^{in} - 1} 〈 \begin{matrix}{N}^{in} - {S}_{k}^{i n} \\ {M}^{in} - k\end{matrix} 〉 , \\ 〈 \begin{matrix}x \\ y\end{matrix} 〉 = \{ \begin{matrix}( \begin{matrix}x \\ y\end{matrix} ) & x \geq y \\ 0 & x < y ,\end{matrix}$$

and wherein Nⁱⁿ is a total number of resource blocks or resource block

$$( \begin{matrix}x \\ y\end{matrix} ) {=}_{x} {C}_{y}$$

groups+1, and Mⁱⁿ is a total number of coefficients, and C is a combination of x into y, wherein the first coefficient for each cluster is the start index of each cluster and the second coefficient for each cluster is a value obtained by adding a constant 1 to the end index of each cluster.

In accordance with an aspect of the present invention, the present invention provides a resource allocation apparatus, comprising: an encoder to generate single resource allocation information (r) by encoding a first coefficient sⁱⁿₖ (wherein, k=2*1, and 1 is an integer) and a second coefficient sⁱⁿₖ (wherein, k=2*1+1, and 1 is an integer), the first coefficient being obtained by converting a start index of one or more clusters including one or more resource blocks or resource block groups, the second coefficient being obtained by converting an end index of the one or more clusters; and a transmitter to transmit the resource allocation information (r) to a user equipment, wherein the resource allocation information is generated by the encoder using

$$r = {\sum }_{k = 0}^{{M}^{in} - 1} 〈 \begin{matrix}{N}^{in} - {S}_{k}^{i n} \\ {M}^{in} - k\end{matrix} 〉 , \\ 〈 \begin{matrix}x \\ y\end{matrix} 〉 = \{ \begin{matrix}( \begin{matrix}x \\ y\end{matrix} ) & x \geq y \\ 0 & x < y ,\end{matrix}$$

and wherein Nⁱⁿ is a total number of resource blocks or resource block

$$( \begin{matrix}x \\ y\end{matrix} ) {=}_{x} {C}_{y}$$

groups+1, and Mⁱⁿ is a total number of coefficients, and C is a combination of x into y, wherein the first coefficient for each cluster is the start index of each cluster and the second coefficient for each cluster is a value obtained by adding a constant 1 to the end index of each cluster.

In accordance with another aspect of the present invention, the present invention provides a method for resource allocation, comprising: generating single resource allocation information (r) by encoding a first coefficient sⁱⁿₖ (wherein, k=2*1, and 1 is an integer) and a second coefficient sⁱⁿₖ (wherein, k=2*1+1, and 1 is a integer), the first coefficient being obtained by converting a start index of one or more clusters including one or more resource blocks or resource block groups, the second efficient being obtained by converting an end index of the one or more clusters; and transmitting the resource allocation information (r) to a user equipment, wherein the resource allocation information is generated by using

$$r = {\sum }_{k = 0}^{{M}^{in} - 1} 〈 \begin{matrix}{N}^{in} - {S}_{k}^{i n} \\ {M}^{in} - k\end{matrix} 〉 , \\ 〈 \begin{matrix}x \\ y\end{matrix} 〉 = \{ \begin{matrix}( \begin{matrix}x \\ y\end{matrix} ) & x \geq y \\ 0 & x < y ,\end{matrix}$$

and wherein Nⁱⁿ is a total number of resource blocks or

$$( \begin{matrix}x \\ y\end{matrix} ) {=}_{x} {C}_{y}$$

resource block groups+1, and Mⁱⁿ is a total number of coefficients, and C is a combination of x into y, wherein the first coefficient for each cluster is the start index of each cluster and the second coefficient for each cluster is a value obtained by adding a constant 1 to the end index of each cluster. In accordance with another aspect of the present invention, the present invention provides a user equipment, comprising: a receiver to receive resource allocation information encoded from information on resources allocated to one or more cluster from a base station; a decoder to decode the resource allocation information and to extract a first coefficient and a second coefficient for the each cluster; and a post-processor to convert the first coefficient and the second coefficient for the first cluster to a start index and an end index of each cluster, respectively, wherein the post-processor converts the first coefficient for the each cluster to the start index of each cluster by substituting the first coefficient with the start index, and converts the second coefficient for each cluster to the end index of each cluster by subtracting a constant 1 from the second coefficient. In accordance with another aspect of the present invention, the present invention provides a resource allocation reception apparatus, comprising: a receiver to receive resource allocation information encoded from information on resources allocated to one or more cluster from a base station; a decoder to decode the resource allocation information and to extract a first coefficient and a second coefficient for each cluster; and a post-processor to convert the first coefficient and the second coefficient for each cluster to a start index and an end index of each cluster, respectively, wherein the post-processor converts the first coefficient for each cluster to the start index of each cluster by substituting the first coefficient with the start index, and converts the second coefficient for each cluster to the end index of each cluster by subtracting a constant 1 from the second coefficient.

In accordance with another aspect of the present invention, the present invention provides a resource allocation reception apparatus, comprising: an encoder to generate single resource allocation information (r) by encoding a first coefficient sⁱⁿₖ (wherein, k=2*1, and 1 is an integer) and a second coefficient sⁱⁿₖ (wherein, k=2*1+1, and 1 is a integer), the first coefficient being determined by converting a start index of each of one or more clusters including one or more resource blocks or resource block groups, the second coefficient sⁱⁿₖ being determined by converting an end index of each of one or more clusters; and a transmitter to transmit the resource allocation information (r) to a user equipment, wherein the resource allocation information is generated by using

$$r = {\sum }_{k = 0}^{{M}^{in} - 1} 〈 \begin{matrix}{N}^{in} - {S}_{k}^{in} \\ {M}^{in} - k\end{matrix} 〉 , \\ 〈 \begin{matrix}x \\ y\end{matrix} 〉 = \{ \begin{matrix}( \begin{matrix}x \\ y\end{matrix} ) & x \geq y \\ 0 & x < y ,\end{matrix}$$

and Nⁱⁿ is a total number of resource blocks or resource block

$$( \begin{matrix}x \\ y\end{matrix} ) {=}_{x} {C}_{y}$$

groups+1, and Mⁱⁿ is a total number of coefficients, wherein the end index is determined by subtracting a constant 1 from the second coefficient

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a wireless communication system according to an exemplary embodiment of the invention.

FIG. 2 is a block diagram illustrating a resource allocation apparatus and a resource allocation reception apparatus according to an exemplary embodiment of the invention.

FIG. 3A, FIG. 3B, and FIG. 3C are diagrams illustrating various resource allocation schemes according to an exemplary embodiment of the invention.

FIG. 4 is a diagram illustrating a resource allocation apparatus according to an exemplary embodiment of the invention.

FIG. 5 is a diagram illustrating resource allocation according to an exemplary embodiment of the invention.

FIG. 6 is a flowchart illustrating a resource allocation method according to an exemplary embodiment of the invention.

FIG. 7 is a diagram illustrating a resource allocation apparatus according to an exemplary embodiment of the invention.

FIG. 8 is a diagram illustrating resource allocation according to an exemplary embodiment of the invention.

FIG. 9 is a flowchart illustrating resource allocation method according to an exemplary embodiment of the invention.

FIG. 10 and FIG. 11 are diagrams illustrating resource allocation apparatuses according to an exemplary embodiment of the invention.

FIG. 12 is a diagram exemplarily illustrating a resource allocation according to an exemplary embodiment of the invention.

FIG. 13 is a flowchart illustrating a resource allocation method according to an exemplary embodiment of the invention.

FIG. 14 is a diagram illustrating a resource allocation reception apparatus according to an exemplary embodiment of the invention.

FIG. 15 is a flowchart illustrating a resource allocation reception method according to an exemplary embodiment of the invention.

FIG. 16 is a diagram illustrating a resource allocation reception apparatus according to an exemplary embodiment of the invention.

FIG. 17 is a flowchart illustrating a resource allocation reception method according to an exemplary embodiment of the invention.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. Various changes, modifications, and equivalents of the systems, apparatuses, and/or methods described herein will likely suggest themselves to those of ordinary skill in the art. Elements, features, and structures are denoted by the same reference numerals throughout the drawings and the detailed description, and the size and proportions of some elements may be exaggerated in the drawings for clarity and convenience.

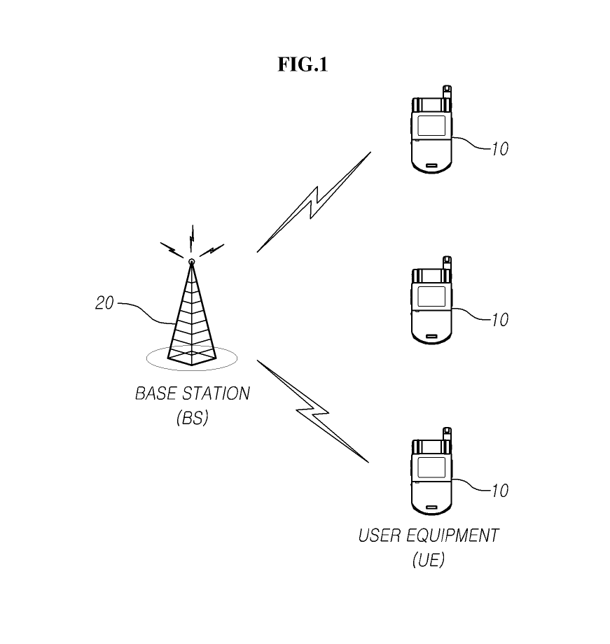

FIG. 1 is a block diagram illustrating a wireless communication system according to an exemplary embodiment of the invention.

The wireless communication systems are provided in order for a user to interact and receive various communication services, such as voice and packet data.

As shown in FIG. 1, the wireless communication system includes multiple UE (User Equipment) 10, each communicating with a BS (Base Station) 20. As described below in this disclosure, the various UE 10 and the BS 20 may make use of various resource allocation methods, such as those as described below.

As described in this disclosure, UE 10 refers to a user terminal in a wireless communication, and may include but is not limited to: a UE in WCDMA (Wideband Code Division Multiple Access), LTE (Long Term Evolution), HSPA (High Speed Packet Access), and the like. UE 10 may also refer to. an MS (Mobile Station), a UT (User Terminal), SS (Subscriber Station), a wireless device in GSM (Global System for Mobile Communication), and other equivalent terminals used in wireless communication systems.

The BS 20 or cell generally refers to a fixed station communicating with the UE 10. The BS 20 may be called by another name, such as Node-B, eNB (evolved Node-B), BTS (Base Transceiver System), AP (Access Point) and other similar or equivalent terminology.

Further, as used in this disclosure, a BS 20 or cell may be considered as an area controlled by a BSC (Base Station Controller) in CDMA, or Node B in WCDMA. Further, the BS 20 may cover areas that include a mega cell, a macro cell, a micro cell, a pico cell, a femto cell, and other equivalents known to one of ordinary skill in the art.

In this disclosure, the UE 10 and the BS 20 are not limited to specifically expressed terms or words as described below. Further, the UE 10 and BS 20 may indicate at least two transmitting and receiving agents used for implementation of the various exemplary embodiments described herein.

Thus, there is no limit to the multiple access schemes applicable to a wireless communication system. Therefore, various multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, and OFDM-CDMA, may be used in conjunction with a wireless communication system.

For example, an uplink transmission and a downlink transmission may use either a TDD (Time Division Duplex) scheme using different times for transmission or an FDD (Frequency Division Duplex) scheme using different frequencies for transmission.

Exemplary embodiments of the present invention may be applied to a resource allocation of an asynchronous wireless communication, that may evolve to or from the LTE (Long Term Evolution) and the LTE-Advanced (LTE-A) through the GSM, the WCDMA, and the HSPA; and to a resource allocation of a synchronous wireless communication, that may evolve to or from the CDMA, the CDMA-2000 and the UMB. The present disclosure should not be limited to a particular wireless communication field, and should be construed to include all technical fields applicable to the concept contained herein.

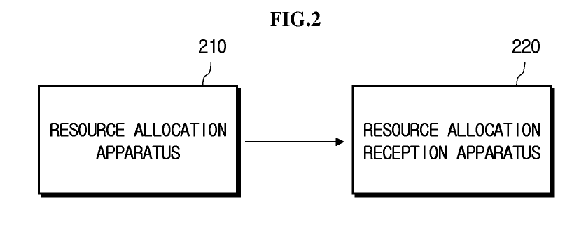

FIG. 2 is a block diagram illustrating a resource allocation apparatus and a resource allocation reception apparatus according to an exemplary embodiment of the invention. Referring to FIG. 2, a resource allocation apparatus 210 and a resource allocation reception apparatus 220 are used for allocating resources in a wireless communication system. The resource allocation apparatus 210 may be a resource allocation apparatus used in conjunction with the BS 20 of FIG. 1, and the resource allocation reception apparatus 220 may be a resource allocation reception apparatus used in conjunction with the UE 10 of FIG. 1.

The resource allocation apparatus 210 generates resource allocation information on one or more combinations of frequency resources and time resources to be allocated to one or more UE 10, after which, it transfers the generated resource allocation information to the resource allocation reception apparatus 220.

For example, in 3GPP LTE (3^{rd} Generation Partnership Project Long Term Evolution), the resource allocation apparatus 210 transfers control information for uplink/downlink communication and resource allocation information on frequency and time resources allocated to each UE 10, through a Physical Downlink Control Channel (PDCCH) transmitted through the downlink communication.

A resource region for the resource allocation may be configured based on the time and the frequency of a Resource Block (RB). In the case of broadband, the number of RBs may increase, thus causing the required bit quantity for indicating the resource allocation information to increase, making it possible to process the resource allocation based on a defined Resource Block Group (RBG), the RBG being obtained by adding several RBs. The resource allocation information indicated with the RB or the RBG may be transmitted in a form of a Resource Indication Value (RIV) within a resource allocation field contained in the PDCCH. The bandwidth considered in the LTE is 1.4/3/5/10/15/20 MHz, which can be also expressed as 6/15/25/50/75/100 on a basis of the number of RBs. Thus, the size P (period) of the RBG is 1/2/2/3/4/4 in an expression by RBs corresponding to each band. Therefore, the number of RBGs corresponding to each band is 6/8/13/17/19/25.

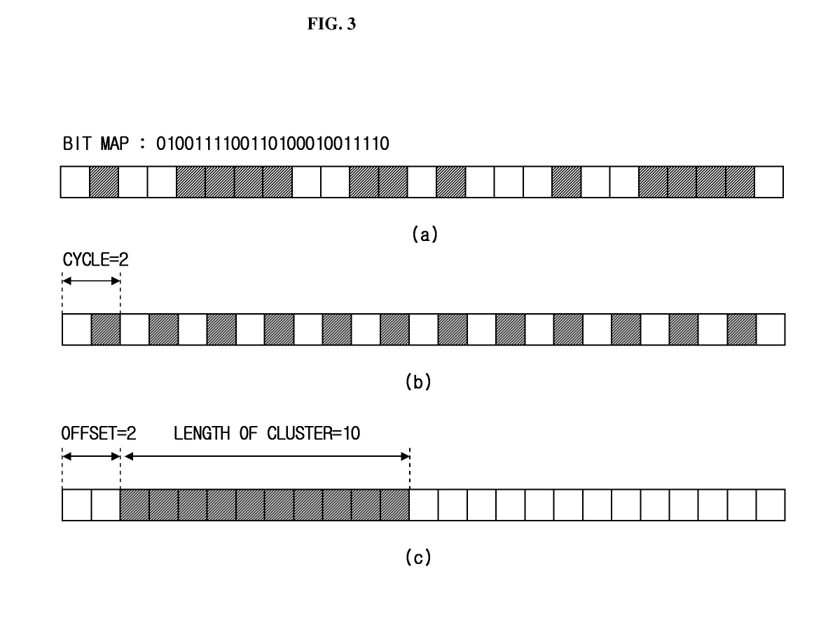

Based on the scheme by which the resource is allocated to the aforementioned resource allocation field, the resource allocation scheme may be classified into types:including type 0, type 1, and type 2. These various types of resource allocation schemes are exemplarily illustrated in FIG. 3A, FIG. 3B, and FIG. 3C, which are diagrams illustrating various resource allocation schemes according to an exemplary embodiment of the invention.

Referring to FIG. 3A, type 0 is shown and depicts the resource allocation region in a bitmap type. That is, by expressing the resource allocation by 1 and non-resource allocation by 0 for each RB or each RBG, it is possible to indicate the resource allocation for the entire band. In the case of the resource allocation is expressed by type 0 and the number of RBs is n, the required bit quantity is

$$⌈ \frac{n}{p} ⌉ .$$

Referring to FIG. 3B, type 1 is shown and depicts the resource allocation region in a cycle type. Specifically, type 1 corresponds to an allocation of resources distributed with a predetermined interval with a predetermined period P in the entire allocation regions. Thus, the relationship of ┌log₂(P)┐ bit corresponds to the size of a subset having the cycle, and 1 bit corresponds to the offset, and

$$⌈ \frac{n}{p} ⌉ - ⌈ {log}_{2} ( P ) ⌉ - 1$$

corresponds to a particular resource allocation. The bit quantity of type 1 may be designed to be identical to that of type 0 for use. Generally, when type 0 and type 1 are used together, a differentiation bit may be added in order to discriminate between type 0 and type 1.

Referring to FIG. 3C, type 2 is shown and depicts allocation for contiguous resource regions with each having a predetermined length. Type 2 is expressed with an offset at a start point (or a point before the start) and a length of the resource allocation region (referred to as ‘a cluster’). While type 0 and type 1 indicate the non-contiguous resource allocation, type 2 indicates and uses only the contiguous resource regions. In this respect, when the number of RBs is large in a system requiring a large band for use, the required bit quantity in type 2 is less than that of type 0 or type 1. The required bit quantity in type 2 is

$$⌈ {log}_{2} \frac{n ( n + 1 )}{2} ⌉ .$$

Therefore, while another resource allocation scheme (i.e. type 0 or type 1) is expressed in the form of the RBG, type 2 can be expressed in the form of the RB. The resource allocation scheme of type 0 shown in FIG. 3A may be interpreted as a resource allocation scheme of type 2, in which each cluster has one RB (or RBG), and the total number of clusters is six. Further, the resource allocation scheme of type 1 shown in FIG. 3B may be considered as the resource allocation scheme of type 2 in which the offset of each cluster is 1 and the length of each cluster is 1.

It may be possible to apply only the resource allocation of type 2 as shown in FIG. 3C, in which the number of contiguous RBs is one, to the uplink. Further, it may be possible to apply to the uplink resource allocation by multiple non-contiguous RBs (i.e. multiple clusters). This is referred to as the ‘non-contiguous resource allocation’, with each block among the multiple non-contiguous blocks being defined as ‘a cluster’. Type 0 shown in FIG. 3A is one type of non-contiguous resource allocation. However, because the resource allocation according to type 0 enables allocation of all possible non-contiguous blocks within an entire range of the given RBG, only a limited number of clusters (e.g. two to four clusters) may be considered for the non-contiguous resource allocation of type 0. As such, the number of clusters such as type 0 may cause more signaling overhead for the resource allocation if the effect of the clustering causes the number of clusters to be larger than a particular number (e.g. four). Thus, the gain through the resource allocation using a lower number of clusters with a regime using type 0 may be small.

The resource allocation apparatus 210 of FIG. 2 and the resource allocation method by the resource allocation apparatus 210 will be described below.

The resource allocation apparatus 210 shown in FIG. 2 includes a pre-processor (not shown) to convert cluster information of each cluster including one or more RBs or RBGs to one or more coefficients used for the generation of the resource allocation information, and an encoder (not shown) to generate resource allocation information by encoding the one or more coefficients converted for each cluster, and a transmitter (not shown) to transmit the generated resource allocation information to the UE 10. The resource allocation apparatus 210 performs a pre-processing step in which cluster information of each cluster including one or more RBs or RBGs is converted to one or more coefficients used for the generation of the resource allocation information, an encoding step in which the one or more coefficients converted for each cluster are encoded and with one resource allocation information being generated, and a transmission step in which the generated resource allocation information is transmitted to the UE 10.

The resource allocation reception apparatus 220 shown in FIG. 2 includes a receiver (not shown) to receive the resource allocation information including information of resources allocated to one or more clusters, a decoder(not shown) to decode the received resource allocation information and to extract one or more coefficients for recognizing information of each cluster, and a post-processor (not shown) to convert the one or more extracted coefficients to cluster information for each cluster including the one or more RBs or RBGs.

The resource allocation reception apparatus 220 performs a reception step in which the resource allocation information including information of resources allocated to one or more clusters is received, a decoding step in which the received resource allocation information is decoded and one or more coefficients for recognizing each cluster information is extracted, and a post-processing step in which the extracted one or more coefficients are converted to cluster information for each cluster including the one or more RBs or RBGs. The pre-processing process described in the specification is inversely related with the post-processing process.

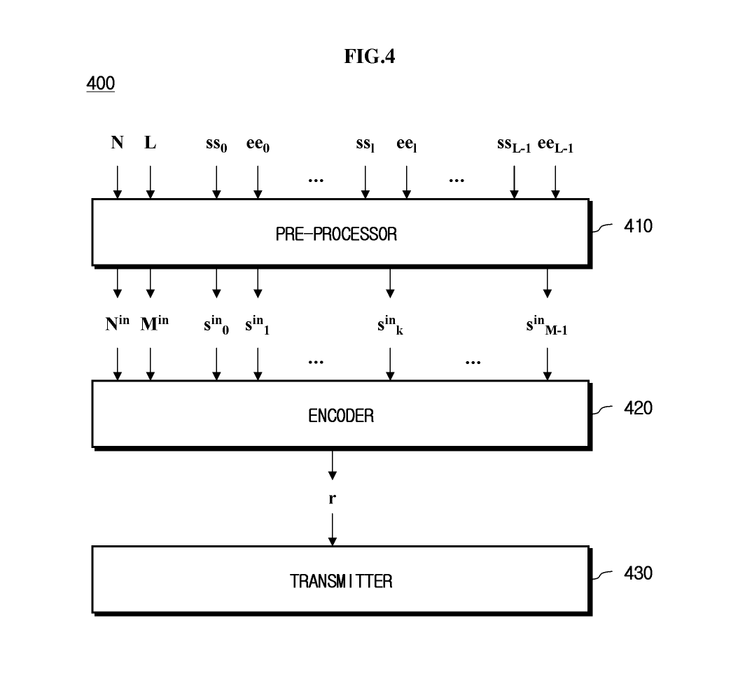

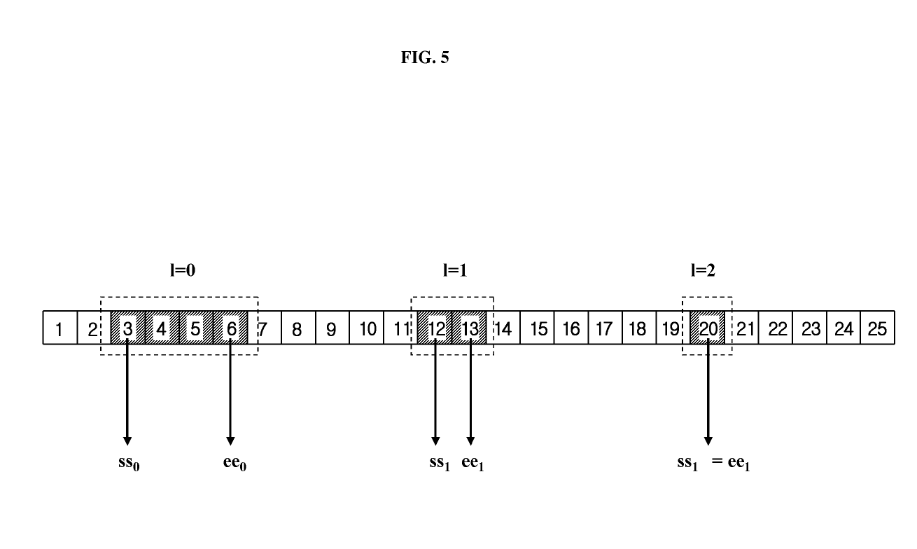

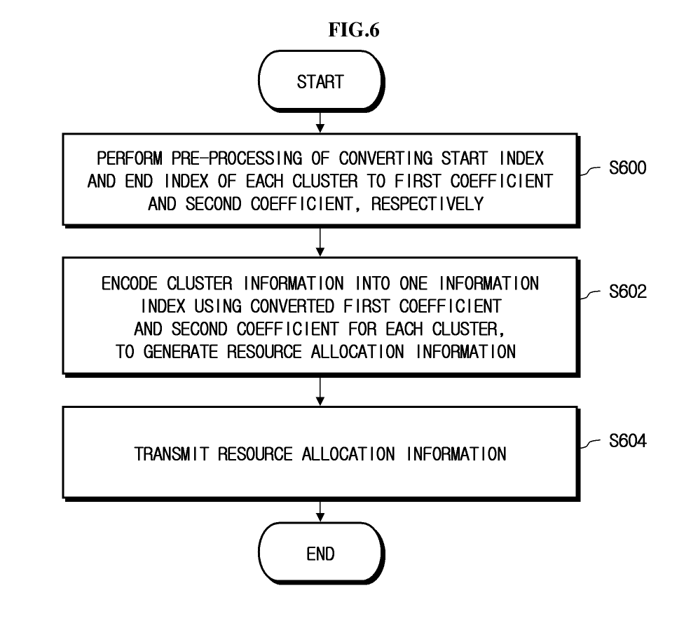

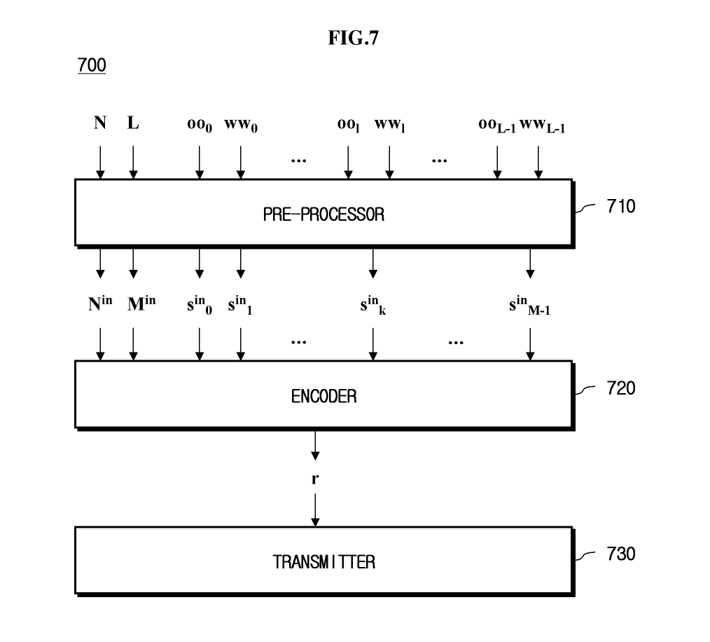

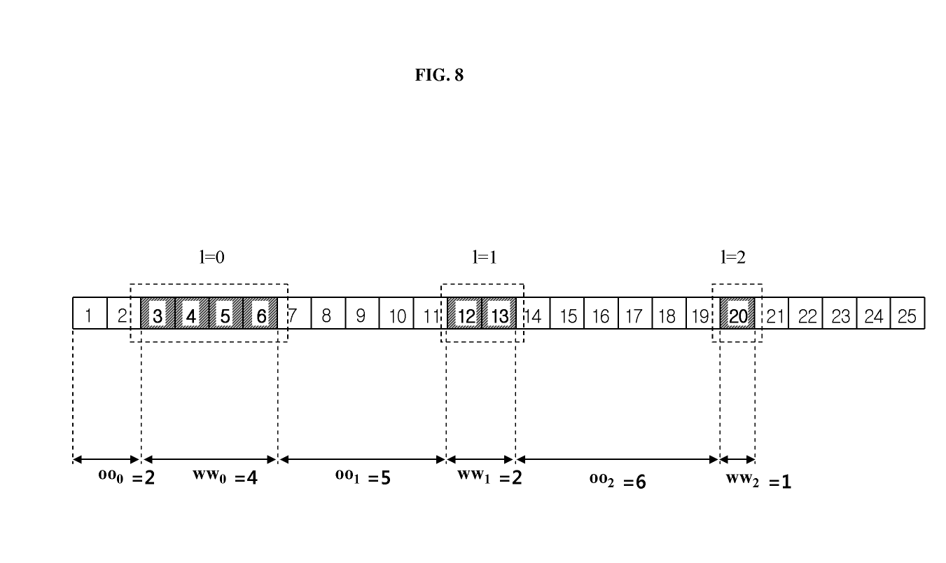

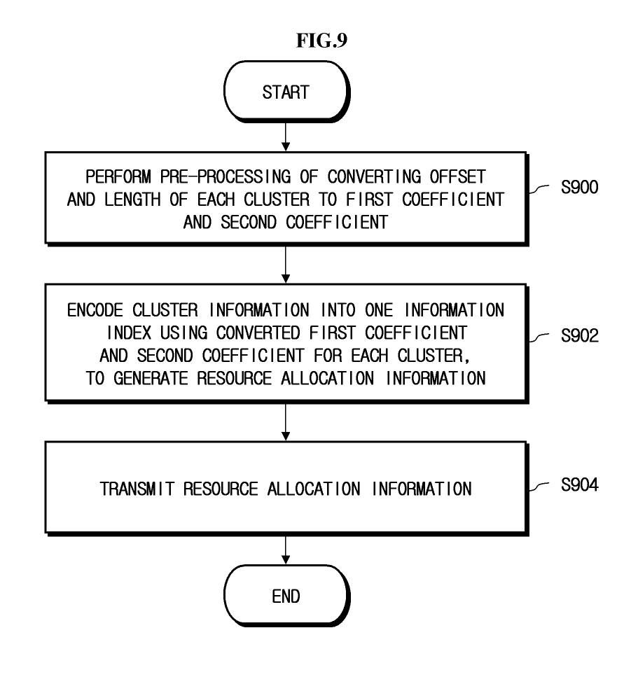

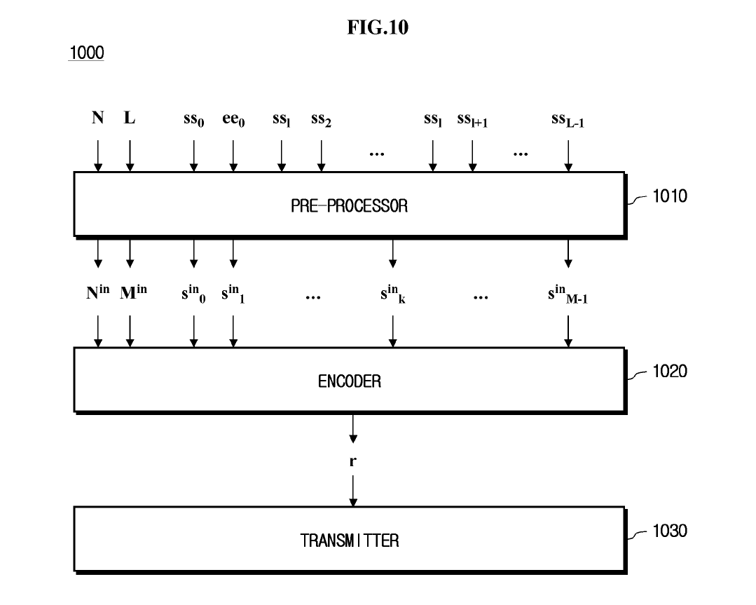

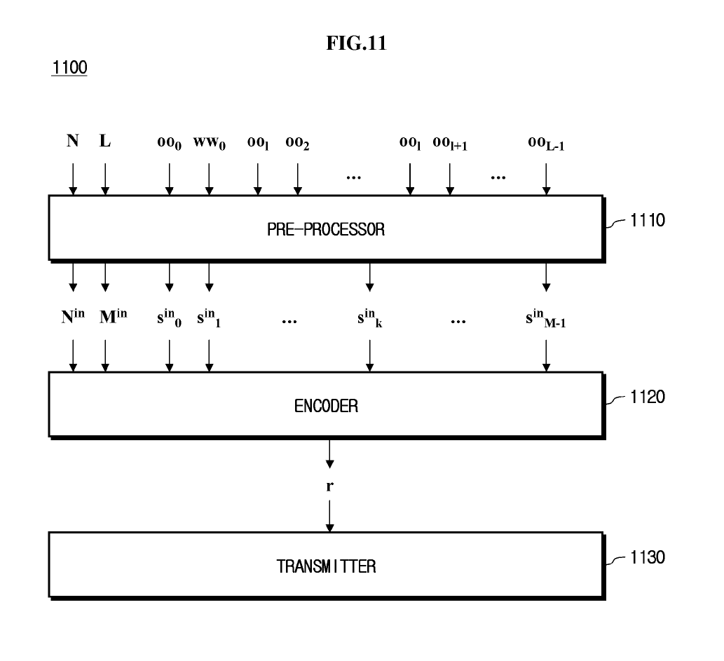

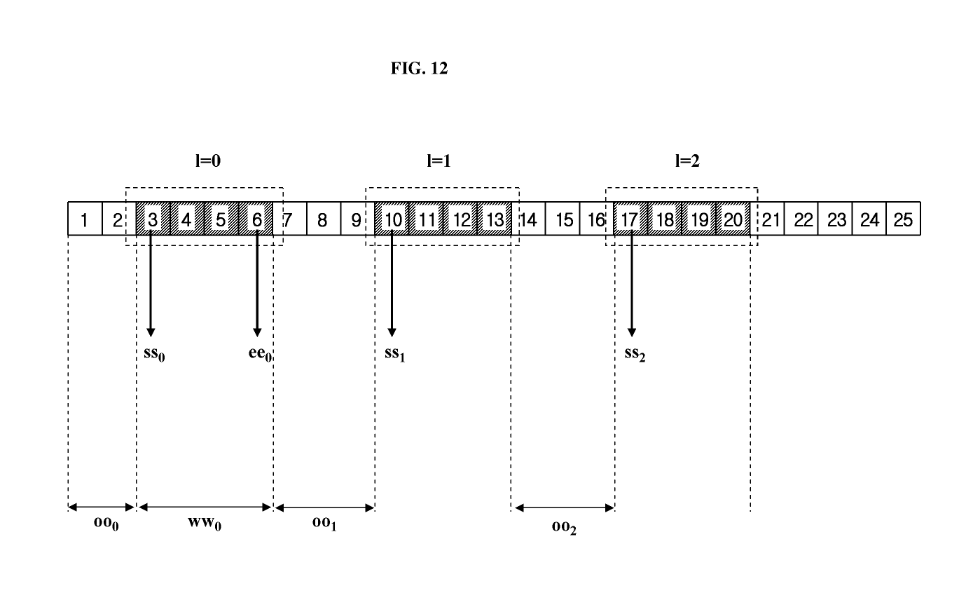

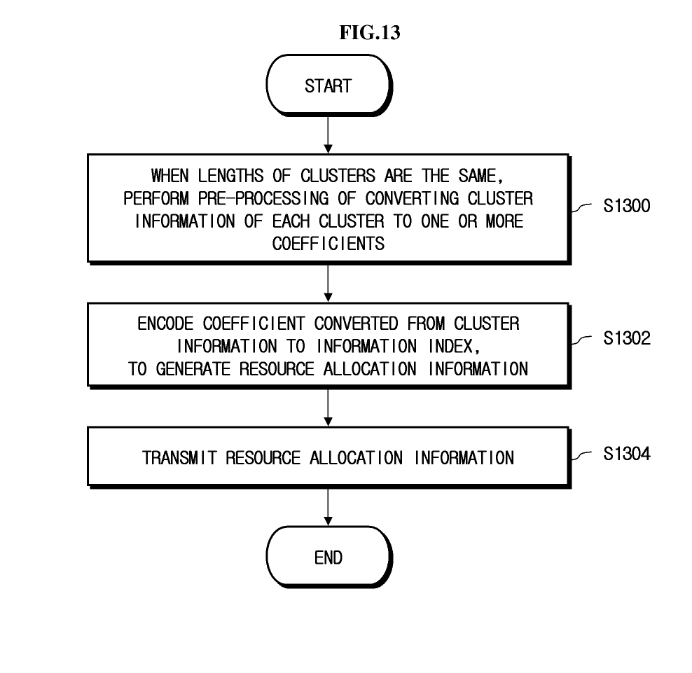

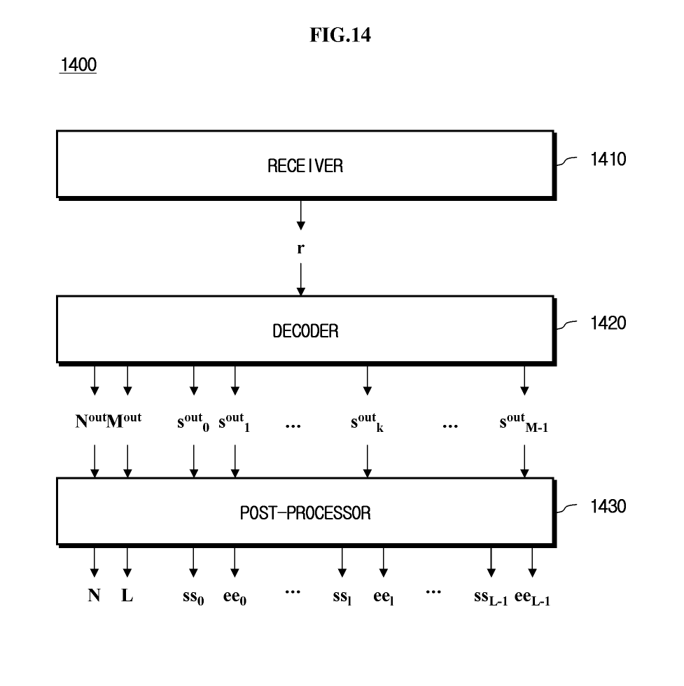

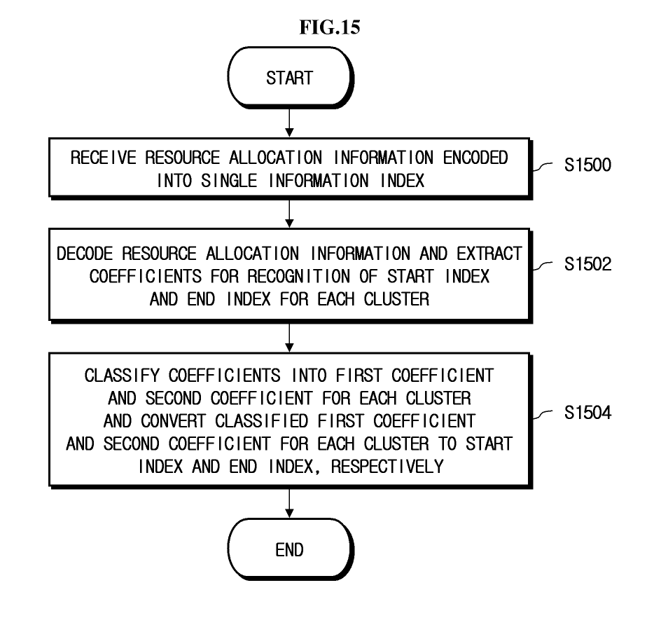

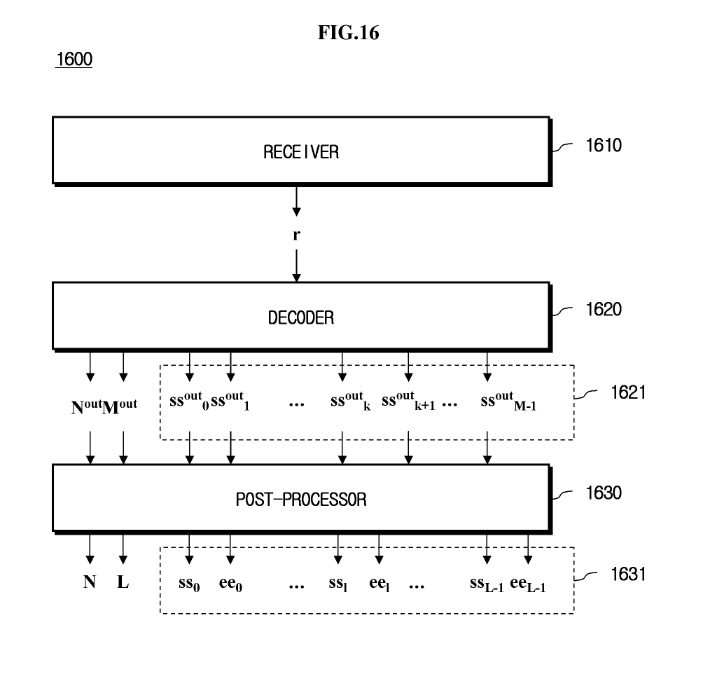

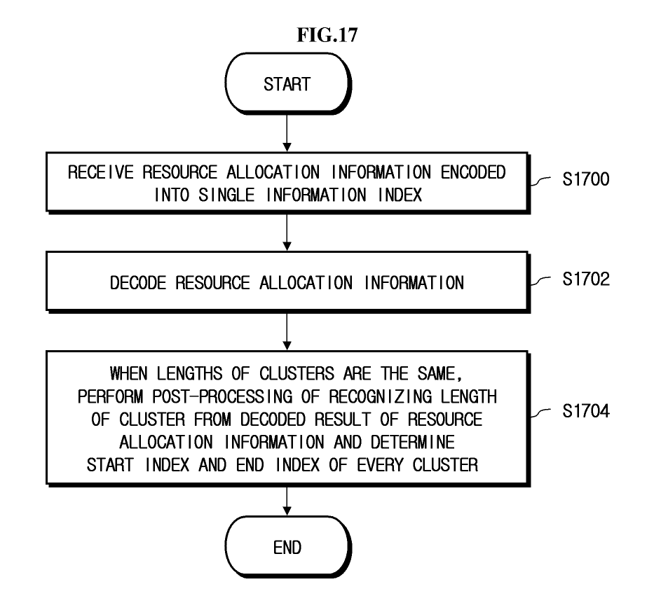

The resource allocation apparatus 210 and the resource allocation method by the resource allocation apparatus 210, and the resource allocation reception apparatus 220 and the resource allocation reception method of the resource allocation reception apparatus 220 have been briefly described. Hereinafter, embodiments of the resource allocation apparatus 210 for the efficient resource allocation and the resource allocation method by the resource allocation apparatus 210 will be described in more detail with reference to FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16 and FIG. 17.

FIG. 4 is a diagram illustrating a resource allocation apparatus according to an exemplary embodiment of the invention. The resource allocation apparatus 400 shown in FIG. 4 may correspond to the resource allocation apparatus 210 shown in FIG. 2.

Referring to FIG. 4, the resource allocation apparatus 400 includes a pre-processor 410, an encoder 420, and a transmitter 430.

The pre-processor 410 converts a start index (ssₗ, 0≦l≦L−1, where L is the number of clusters) and an end index (eeₗ, 0≦l≦L−1, where L is the number of clusters) of each of the one or more clusters including one or more RBs or RBGs to a first coefficient and a second coefficient used for the generation of the resource allocation information (r), respectively. The encoder 420 generates the resource allocation information (r) by encoding information of the coefficients (sⁱⁿₖ, 0≦k≦M−1, M=Mⁱⁿ=2*L) including the converted first coefficient and second coefficient for each cluster (i.e. for each value 1, 0≦l≦L−1). The transmitter 430 transmits the resource allocation information (r) to the UE 10, with r having been encoded and generated by the encoder 420.

The pre-processor 410 converts the start index and the end index of each cluster to the first coefficient and the second coefficient, respectively. In this regard, the converted second coefficient is larger than the first coefficient. Where a length (the number of RBs or RBGs included in the cluster) of the cluster in which the start index and the end index are the same is 1, subsequently, the pre-processor 410 may convert the second coefficient of each cluster to a value larger than the first coefficient using the restrictive condition of an enumerative source coding.

In order to make the sizes of the second coefficient converted from the end index and the first coefficient converted from the start index of each cluster to meet the size condition (i.e. the first coefficient<the second coefficient), the pre-processor 410 may convert the start index and the end index to the first coefficient and the second coefficient satisfying the size condition by the methodology described below.

In order to make the second coefficient and the first coefficient meet the size condition, the pre-processor 410 may convert, with respect to each cluster, the start index to the first coefficient by substituting the start index with the first coefficient and converts the end index to the second coefficient by adding a constant (e.g. 1 or a value larger than 1, which may be set according to a resource allocation policy of the interval (offset) between the clusters) to the end index. The conversion scheme may be expressed by Equation (1) below. Equation (1) is expressed on an assumption that the constant, 1, is added to the end index. In Equation (1), ssₗ corresponds to the start index of the l^{th} cluster (wherein, 0≦l≦L−1), eeₗ corresponds to the end index of the l^{th} cluster, sⁱⁿ₂ₗ corresponds to the first coefficient converted from the start index of the l^{th} cluster, and sⁱⁿ₂ₗ₊₁ corresponds to the second coefficient converted from the end index of the l^{th} cluster.

s₂ₗⁱⁿ=ssₗ,

s₂ₗ₊₁ⁱⁿ=eeₗ+1,

Nⁱⁿ=N+1,

Mⁱⁿ=2L Equation (1)

In Equation (1), N corresponds to the total number of RBs or RBGs. The pre-processor 410 converts N to Nⁱⁿ by adding a constant (e.g. 1) to N. Further, in Equation (1), Mⁱⁿ corresponds to the total number of coefficients, L corresponds to the total number of clusters, and Mⁱⁿ is converted by multiplying L by 2.

In order to make the second coefficient and the first coefficient meet the aforementioned size condition, the pre-processor 410 may convert, with respect to each cluster, the start index to the first coefficient by subtracting the constant (e.g. 1 or a value larger than 1, which may be set according to a resource allocation policy of an interval (offset) between the is clusters) from the start index, and then convert the end index to the second coefficient by substituting the end index with the second coefficient. This conversion may be expressed by Equation (2) below. Equation (2) is based on an assumption that the constant, 1, is subtracted from the start index. In Equation (2), ssₗ corresponds to the start index of the l^{th} cluster (wherein, 0≦l≦L−1), eeₗ corresponds to the end index of the l^{th} cluster, sⁱⁿ₂ₗ corresponds to the first coefficient converted from the start index of the l^{th} cluster, and sⁱⁿ₂ₗ₊₁ corresponds to the second coefficient converted from the end index of the l^{th} cluster.

s₂ₗⁱⁿ=ssₗ−1,

s₂ₗ₊₁ⁱⁿ=eeₗ,

Nⁱⁿ=N+1,

Mⁱⁿ=2L Equation (2)

In Equation (2), N corresponds to the total number of RBs or RBGs. Since the number of RBs or RBGs included in a corresponding cluster is increased by 1, which corresponds to the value subtracted from the start index, the pre-processor 410 converts N to Nⁱⁿ by adding the constant (e.g. 1) to N. Further, in Equation (2), Mⁱⁿ corresponds to the total number of coefficients, L corresponds to the total number of clusters, and Mⁱⁿ is converted from L by multiplying L by 2.

Referring to FIG. 4, after the pre-processor 410 converts the start index and the end index of each cluster to the first coefficient and the second coefficient used by the encoder 420 for the generation of the resource allocation information, respectively, the encoder 420 receives the coefficients (sⁱⁿ₂ₗ and sⁱⁿ₂ₗ₊₁, 0≦l≦L−1) including the first coefficient and the second coefficient and other calculated information (Nⁱⁿ and Mⁱⁿ), and generates the resource allocation information (r) for transmission by transmitter 430.

The encoder 420 generates the resource allocation information (r) by using Equation (3), through an enumerative source coding scheme based on the total number N of RBs or RBGs, the total number L of clusters, and the converted first coefficient sⁱⁿ₂ₗ and second coefficient sⁱⁿ₂ₗ₊₁ for each cluster.

$$\begin{matrix}r = {\sum }_{k = 0}^{{M}^{in} - 1} 〈 \begin{matrix}{N}^{in} - {S}_{k}^{in} \\ {M}^{in} - k\end{matrix} 〉 \\ = {\sum }_{l = 0}^{L - 1} ( 〈 \begin{matrix}{N}^{in} - {S}_{2 l}^{in} \\ {M}^{in} - 2 l\end{matrix} 〉 + 〈 \begin{matrix}{N}^{in} - {2}_{2 l + 1}^{in} \\ {M}^{in} - ( 2 L + 1 )\end{matrix} 〉 ) ,\end{matrix} \\ 〈 \begin{matrix}x \\ y\end{matrix} 〉 = \{ \begin{matrix}( \begin{matrix}x \\ y\end{matrix} ) & x \geq y \\ 0 & x < y ,\end{matrix} \\ ( \begin{matrix}x \\ y\end{matrix} ) {=}_{x} {C}_{y} \qquad Equation ( 3 )$$

A method for generating the resource allocation information through the encoding using Equation (3) will be described with reference to FIG. 5.

FIG. 5 is a diagram illustrating resource allocation according to an exemplary embodiment of the invention.

In FIG. 5, the resources among the 25 RBGs have been allocated to three clusters, including a cluster having four RBGs (RBGs 3 to 6), a cluster having two RBGs (RBGs 12 and 13), and a cluster having one RBG (RBG 20). Thus, the value of N (the total number of RBGs) is 25, and the value of L (the total number of clusters) is 3. Once these values are obtained, a method for generating the resource allocation information to be notified to the resource allocation reception device in the resource allocation is explained below.

Referring to FIG. 5, a start index ss₀ and an end index ee₀ of the first cluster (the cluster with 1=0) are 3 and 6, respectively. A start index ss₁ and an end index ee₁ of the second cluster (the cluster with 1=1) are 12 and 13, respectively. Both of the start index ss₂ and the end index ee₂ of the third cluster (the cluster with 1=2) are identically 20.

According to Equation (1), the first coefficient sⁱⁿ₀ is 3, and the second coefficient sⁱⁿ₁ is 7(=6+1) for the first cluster (the cluster with 1=0). According to Equation (1), the first coefficient sⁱⁿ₂ is 12, and the second coefficient sⁱⁿ₃ is 14(=13+1) for the second cluster (the cluster with 1=1). According to Equation (1), the first coefficient sⁱⁿ₄ is 20, and the second coefficient sⁱⁿ₅ is 21(=20+1) for the third cluster (the cluster with 1=2). Further, according to Equation (1), Nⁱⁿ is 26(=N+1=25+1), and Mⁱⁿ is 6(=2*L=2*3).

By utilizing the obtained values into Equation (3), it is possible to obtain the following encoded resource allocation information (r).

$$\begin{matrix}r = {\sum }_{k = 0}^{6 - 1} 〈 \begin{matrix}26 - {s}_{k}^{in} \\ 6 - k\end{matrix} 〉 \\ = 〈 \begin{matrix}26 - 3 \\ 6 - 0\end{matrix} 〉 + 〈 \begin{matrix}26 - 7 \\ 6 - 1\end{matrix} 〉 + 〈 \begin{matrix}26 - 12 \\ 6 - 2\end{matrix} 〉 + 〈 \begin{matrix}26 - 14 \\ 6 - 3\end{matrix} 〉 + \\ 〈 \begin{matrix}26 - 20 \\ 6 - 4\end{matrix} 〉 + 〈 \begin{matrix}26 - 21 \\ 6 - 5\end{matrix} 〉 \\ = 100949 + 11628 + 1001 + 220 + 15 + 5 \\ = 113816\end{matrix}$$

FIG. 6 is a flowchart illustrating a resource allocation method according to an exemplary embodiment of the invention.

Referring to FIG. 6, the resource allocation method of the resource allocation apparatus 400 includes a pre-processing step (S600) in which a start index and an end index of each of one or more clusters including one or more RBs or RBGs are encoded to a first coefficient and a second coefficient used for the generation of resource allocation information, respectively, an encoding step (S602) in which the converted first coefficient and second coefficient for each cluster are encoded to generate the resource allocation information, and a transmission step (S604) in which the resource allocation information is transmitted to the UE.

The functions corresponding to those performed in each of the pre-processor 410 and the encoder 420 of FIG. 4 are performed in the aforementioned pre-processing step S600 and the encoding step 602.

The above disclosure describes an embodiment of the resource allocation apparatus 210 shown in FIG. 2, i.e. the resource allocation apparatus 400 and the resource allocation method by the resource allocation apparatus 400 with reference to FIG. 4, FIG. 5, and FIG. 6. Hereinafter, an embodiment of the resource allocation apparatus 210 shown in FIG. 2, i.e. a resource allocation apparatus 700 and a resource allocation method by the resource allocation apparatus 700 will be described with reference to FIG. 7, FIG. 8, and FIG. 9.

FIG. 7 is a diagram illustrating a resource allocation apparatus according to an exemplary embodiment of the invention. The resource allocation apparatus 700 shown in FIG. 7 may correspond to an embodiment of the resource allocation apparatus 210 shown in FIG. 2.

As illustrated in FIG. 7, the resource allocation apparatus 700 includes a pre-processor 710, an encoder 720, and a transmitter 730.

Referring to FIG. 7, the pre-processor 710 converts an offset (ooₗ, 0≦l≦L−1, and L is the number of clusters) and a length (wwₗ, 0≦l≦L−1, and L is the number of clusters) of each of one or more clusters including one or more RBs or RBGs to a first coefficient and a second coefficient used for the generation of the resource allocation information (r), respectively. The encoder 720 generates the resource allocation information (r) by encoding information of the coefficients (sⁱⁿₖ, 0≦k≦M−1, and M=Mⁱⁿ=2*L) including the first coefficient and the second coefficient converted for each cluster. The transmitter 730 transmits the resource allocation information (r) generated in the encoder 720 to the UE 10.

In converting the offset and the length of each cluster to the first coefficient and the second coefficient, respectively, the pre-processor 710 obtains a start index and an end index from the offset and the length of each cluster and then converts the obtained start index and end index to the first coefficient and the second coefficient, respectively. In this regard, converting the start index and the end index obtained from the offset and the length of each cluster to the first coefficient and the second coefficient, respectively, is substantially similar to the conversion performed by the pre-processor 410, so that a description thereof will refer to the above description.

Thus, in a case where there are no clusters before a corresponding cluster of which the offset and the length are to be converted, the pre-processor 710 obtains the start index and the end index of the corresponding cluster from the offset and the length of the corresponding cluster. When there is a cluster before a corresponding cluster of which the offset and the length are to be converted, the pre-processor 710 obtains the start index and the end index of the corresponding cluster from the offset and the length of a previous cluster and the offset and the length of the corresponding cluster. Then, the pre-processor 710 converts the obtained start index and end index for each cluster to the first coefficient and the second coefficient used for the generation of the resource allocation information, respectively. It is possible to obtain the start index ssₗ and the end index eeₗ from the offset and the length of the first cluster by Equation (4) below. In Equation (4), i corresponds to a number of a cluster, and i=1−1 corresponds to a cluster just before the l^{th} cluster.

$${ss}_{l} = {\sum }_{i = 0}^{l - 1} ( {oo}_{i} + {ww}_{i} ) + {oo}_{l} + 1 \\ {ee}_{l} = {\sum }_{i = 0}^{l} ( {oo}_{i} + {ww}_{i} ) \qquad Equation ( 4 )$$

The pre-processor 710 converts the offset and the length for each cluster to the first coefficient and the second coefficient, respectively. At this time, the converted second coefficient is equal to or larger than the first coefficient. When the length (the number of RBs or RBGs included in the cluster) of the cluster in which the start index and the end index identically is 1, the pre-processor 710 converts the second coefficient of each cluster to a value larger than the first coefficient using enumerative source coding.

As described above, the conversion used to make the sizes of the second coefficient and the first coefficient meet the size condition (i.e. the first coefficient<the second coefficient) is substantially similar to the conversion (i.e. subtracting or adding a constant) performed by the pre-processor 410 of FIG. 4.

The aforementioned length of each cluster is the number of RBs or RGBs included in each cluster.

FIG. 8 is a diagram illustrating resource allocation according to an exemplary embodiment of the invention.

Similarly to that shown in FIG. 5, in FIG. 8, the resources among the 25 RBGs have been allocated to three clusters, including a cluster having four RBGs (RBGs 3 to 6), a cluster having two RBGs (RBGs 12 and 13), and a cluster having one RBG (RBG 20). Thus, N (the total number of RBGs) is 25, and L (the total number of clusters) is 3. Another method for generating the resource allocation information to be notified to the resource allocation reception device for the resource allocation will be described.

Referring to FIG. 8, the offset oo₀ and the length ww₀ of the first cluster (the is cluster with 1=0) are 2 and 4, respectively. The offset oo₁ and the length ww₁ of the second cluster (the cluster with 1=1) are 5 and 2, respectively. The offset oo₂ and the length ww₂ of the third cluster (the cluster with 1=2) are 6 and 1, respectively.

According to Equation (4), it is possible to obtain the start index and the end index from the offset and the length. According to (4), the start index ss₀ and the end index ee₀ of the first cluster (the cluster with 1=0) are obtained as 3 and 6 from the offset oo₀ and the length ww₀ of the first cluster (the cluster with 1=0), respectively. According to (4), the start index ss₁ and the end index ee₁ of the second cluster (the cluster with 1=1) are obtained as 12 and 13 from the offset oo₁ and the length ww₁ of the second cluster (the cluster with 1=1), respectively.

According to Equation (4), both of the start index ss₂ and the end index ee₂ of the third cluster (the cluster with 1=2) are identically obtained as 20 from the offset oo₂ and the length ww₂ of the third cluster (the cluster with 1=2).

Thus, the conversion of the first coefficient and the second coefficient, and the encoding process are identically performed with the example of FIG. 5.

FIG. 9 is a flowchart illustrating resource allocation method according to an exemplary embodiment of the invention. The resource allocation method shown in FIG. 9 may be performed by the resource allocation apparatus 700.

Referring to FIG. 9, the resource allocation method by the resource allocation apparatus 700 includes a pre-processing step (S900) in which an offset and a length of each of one or more clusters including one or more RBs or RBGs are converted to a first coefficient and a second coefficient used for the generation of the resource allocation information, respectively, an encoding step (S902) in which the first coefficient and the second coefficient converted for each cluster are encoded to generate the resource allocation information, and a transmission step (S904) in which the resource allocation information is transmitted to the UE 10.

The functions corresponding to those performed in each of the pre-processor 710 and the encoder 720 are performed in the aforementioned pre-processing step (S900) and the encoding step (S902).

Hereinafter, an embodiment of the resource allocation apparatus 210 shown in FIG. 2, i.e. resource allocation apparatuses 1000 and 1100, and a resource allocation method by the resource allocation apparatuses 1000 and 1100 will be described with reference to FIG. 10, FIG. 11, FIG. 12, and FIG. 13.

FIG. 10 and FIG. 11 are diagrams illustrating resource allocation apparatuses according to an exemplary embodiment of the invention. The resource allocation apparatuses 1000 and 1100 correspond to an embodiment of the resource allocation apparatus 210 shown in FIG. 2, and may perform the resource allocation if the lengths of all the clusters are the same. The resource allocation apparatus 1000 of FIG. 10 performs the resource allocation by using the start index and the end index as the cluster information of each cluster, and the resource allocation apparatus 1100 of FIG. 10 performs the resource allocation by using the offset and the length (the length of the cluster) as the cluster information of each cluster.

As illustrated in FIG. 10, the resource allocation apparatus 1000 by using the start index and the end index as the cluster information of each cluster includes a pre-processor 1010, an encoder 1020, and a transmitter 1030.

Referring to FIG. 10, the pre-processor 1010 converts the cluster information for each of the one or more clusters included one or more RBs or RBGs to one or more coefficients (a first coefficient and/or a second coefficient) used for the generation of the resource allocation information. In this case, as the lengths of all the clusters are the same for the efficient generation of the resource allocation information, the pre-processor 1010 converts the cluster information including both of the start index ss₀ and the end index ee₀ to two coefficients (i.e. the first coefficient sⁱⁿ₀ and the second coefficient sⁱⁿ₁) for at least one particular cluster (hereinafter, referred to as ‘a first cluster’) for the recognition of the length of the cluster. With respect to one or more remaining clusters (hereinafter, also referred to as ‘a second cluster’) except for the first cluster for the purpose of the notification of the length of the cluster, the pre-processor 1010 converts the cluster information including either start index ss₁, ss₂, . . . , ss_{L-1} or end index to one coefficient (the first coefficient or the second coefficient). FIG. 10 is illustrated on an assumption that the number of first clusters for the notification of the length of the cluster is 1, and the start index is used for the second cluster. Depending on a particular situation, the number of first clusters may be two or more, and the cluster information of the second cluster may be used as the end index, and not the start index.

In the case that the lengths of the one or more clusters including one or more RBs or RBGs are the same, the encoder 1020 encodes the cluster information into an information index to generate the resource allocation information (r) by using the cluster information including both of the start index and the end index for the one or more clusters (first cluster or clusters) and by using the cluster information including only one of the start index or the end index for the remaining cluster or clusters (second cluster or clusters) among all the remaining clusters.

The transmitter 1030 transmits the resource allocation information (r) generated in the encoder 1020 to the UE 10.

The resource allocation apparatus 1000 of FIG. 10 is different from the resource allocation apparatus 400 of FIG. 4 and the resource allocation apparatus 700 of FIG. 7 for at least the reasons described below.

The resource allocation apparatus 400 of FIG. 4 generates the resource allocation information by using both of the start index and the end index of each of all the clusters, while the resource allocation apparatus 700 of FIG. 7 generates the resource allocation information by using both of the offset and the length of each of all the clusters. Therefore, the total number Mⁱⁿ of coefficients of the resource allocation apparatus 400 of FIG. 4 and the resource allocation apparatus 700 of FIG. 7 is two times (2L) of the total number L of clusters.

To the contrary, the resource allocation apparatus 1000 of FIG. 10 does not use both of the start index and the end index of each of all the clusters, nor both of the offset and the length of each of all the clusters. Instead, the resource allocation apparatus 1000 of FIG. 10 uses both of the start index and the end index only for the first cluster (for the length of the cluster, and uses only one of the start index and end index for the remaining clusters. Therefore, the total number Mⁱⁿ of coefficients in the resource allocation apparatus 1000 of FIG. 10 has a value obtained by adding 1 to the total number L of clusters (i.e. L+1). Thus, because a lesser value for Mⁱⁿ may be used, the resource allocation apparatus 1000 of FIG. 10 may generate the resource allocation information utilizing a smaller quantity of bits.

The encoder 1020 in the resource allocation apparatus 1000 of FIG. 10 may generate encoded resource allocation information according to enumerative source coding by using both of the start index and the end index for only one or more first clusters among all the clusters, and by using only one of the start index and the end index for the remaining cluster or clusters (second cluster or clusters) based on all the clusters, the total number N of RBs or RBGs, and the total number L of clusters. The encoded resource allocation information can be calculated by using Equation (5) below.

$$\begin{matrix}\begin{matrix}r = {\sum }_{k = 0 , k \neq K}^{{M}^{ i n} - 1} 〈 \begin{matrix}{N}^{i n} - {s}_{k}^{i n} \\ {M}^{ i n} - k\end{matrix} 〉 \\ = {{\sum }_{l = 0}}^{L - 1} 〈 \begin{matrix}{N}^{i n} - {s}_{l}^{i n} \\ {M}^{i n} - l\end{matrix} 〉 + 〈 \begin{matrix}{N}^{i n} - {e}_{K}^{i n} \\ {M}^{i n} - K\end{matrix} 〉 ,\end{matrix} & Equation 5 \\ or & \\ \begin{matrix}r = {\sum }_{K = 0 , k \neq K}^{{M}^{ i n} - 1} 〈 \begin{matrix}{N}^{i n } - {s}_{k}^{i n} \\ {M}^{i n} - k\end{matrix} 〉 \\ = {\sum }_{l = 0}^{L - 1} 〈 \begin{matrix}{N}^{i n} - {e}_{l}^{i n} \\ {M}^{ i n} - l\end{matrix} 〉 + 〈 \begin{matrix}{N}^{i n} - {s}_{k}^{i n} \\ {M}^{ i n} - K\end{matrix} 〉\end{matrix} & \\ 〈 \begin{matrix}x \\ y\end{matrix} 〉 = \{ \begin{matrix}( \begin{matrix}x \\ y\end{matrix} ) & x \geq y \\ 0 & x < y ,\end{matrix} & \\ ( \begin{matrix}x \\ y\end{matrix} ) {=}_{x} {C}_{y} & \\ {N}^{i n} = N , {M}^{i n} = L + 1 \\ For 1 < K , {s}_{l}^{i n} = {ss}_{l} \\ For 1 = K , {s}_{k}^{i n} = {ss}_{K} = {ee}_{K} , \\ For 1 > K , {s}_{l + 1}^{i n} = {ss}_{l} , or \\ {N}^{i n} = N , {M}^{i n} = L + 1 \\ For 1 < K , {s}_{l}^{i n} = {ee}_{l} \\ For 1 = K , {s}_{k}^{i n} = {ss}_{K} , {s}_{K + 1}^{i n} = {ee}_{K} \\ For 1 > K , {s}_{l + 1}^{i n} = {ee}_{l} , or \\ {N}^{i n} = N , {M}^{ i n} = L + 1 \\ For 1 < K , {s}_{l}^{i n} = {ss}_{l} \\ For 1 = K , {s}_{k}^{i n} = {ss}_{K} , {s}_{K + 1}^{i n} = {ee}_{K} + 1 \\ For 1 > K , {s}_{l + 1}^{i n} = {ss}_{l} , or \\ {N}^{i n} = N , {M}^{i n} = L + 1 \\ For 1 < K , {s}_{l}^{i n} = {ee}_{l} \\ For 1 = K , {s}_{k}^{i n} = {ss}_{k} , {s}_{K + 1}^{i n} = {ee}_{K} + 1 \\ For 1 > K , {s}_{l + 1}^{i n} = {ee}_{l} + 1 & \end{matrix}$$

In Equation (5), K (0≦K≦L−1) corresponds to the index indicating the first cluster among the clusters. It is noted that both of the start index ssₖ and the end index eeₖ are used only for the first cluster (1=K), while only one of the start index ss₁ and the end index ee₁ is used in the second cluster (1<K or 1>K).

Meanwhile, if the end index is converted by adding the constant 1 to the end index as expressed in Equation (1), Nⁱⁿ is N+1, and eeₖ+1 and eeₗ+1 are substituted instead of eeₖ and eeₗ in Equation (5), respectively.

In the exemplary embodiment described in FIG. 10, the resource allocation apparatus 1000 performing the resource allocation by using the start index and the end index as the cluster information of each of the clusters having the same length is described. Hereinafter, a resource allocation apparatus 1100 performing the resource allocation using the offset and the length as the cluster information in the case where each of the clusters have the same length will be described with reference to FIG. 11.

As illustrated in FIG. 11, the resource allocation apparatus 1100 using the offset and the length as the cluster information of each cluster includes a pre-processor 1110, an encoder 1120, and a transmitter 1130. Referring to FIG. 11, the pre-processor 1110 converts the cluster information of each of the one or more clusters including one or more RBs or RBGs to one or more coefficients (a first coefficient and/or a second coefficient) used in the generation of a resource allocation information. In the resource allocation apparatus 1100 shown in FIG. 11, as the lengths of all the clusters are the same, for the efficient generation of the resource allocation information, the pre-processor 1110 converts the cluster information including both of the offset oo₀ and the length ww₀ to two coefficients (i.e. the first coefficient sⁱⁿ₀ and the second coefficient sⁱⁿ₁) for one or more first clusters for the notification of the length of the cluster. With respect to the one or more remaining second clusters, and except for the first cluster (which is used for the purpose of the notification of the length of the cluster), the pre-processor 1110 converts the cluster information including only the offsets for oo₁, oo₂, . . . , and oo_{L-1} for a single coefficient (the first coefficient or the second coefficient). FIG. 11 is illustrated on an assumption that the number of first clusters for the notification of the length of the cluster is 1.

In a case where the lengths of the one or more clusters including the one or more RBs or RBGs are the same, the encoder 1120 encodes the cluster information into the information index to generate the resource allocation information (r) by using the cluster information including both the offset and the length for the one or more clusters (first cluster or clusters) and by using the cluster information that includes only the offset for the remaining cluster or clusters (second cluster or clusters). In this encoding, the encoder 1120 converts the offset and the length to the start index and the end index by using Equation (4), which expresses the relation between the start index/end index and the offset/length. The encoder 1120 generates resource allocation information (r) and converts this information into a single information index, by using Equation (5). Generation of the resource allocation information is accomplished by using enumerative source coding.

The transmitter 1130 transmits the resource allocation information (r) generated in the encoder 1120 to the UE 10.

An example of the resource allocation by the resource allocation apparatuses 1000 and 1100 will be described below.

FIG. 12 is a diagram exemplarily illustrating the resource allocation according to an exemplary embodiment of the present invention.

In FIG. 12, it is assumed that among the 25 RBGs, the resources are allocated to three clusters, and the lengths of the three clusters are identically a length of 4.

Referring to FIG. 12, the start index ss₀ and the end index ee₀ of the first cluster (the cluster with 1=0) are 3 and 6, respectively. The start index ss₁ and the end index ee₁ of the second cluster (the cluster with 1=1) are 10 and 13, respectively. The start index ss₂ and the end index ee₂ of the third cluster (the cluster with 1=2) are 17 and 20, respectively.

In this case, the resource allocation apparatus 1000 of FIG. 10 does not generate the resource allocation information by using both of the start index and the end index of each cluster. Instead, as illustrated in FIG. 12, the resource allocation apparatus 1000 of FIG. 10 generates the resource allocation information by using both of the start index ss₀ and the end index ee₀ for only the cluster with 1=0, and by using only the start index ss₁ and the start index ss₂ for the cluster with 1=1 and the cluster with 1=2. As described above, because it is possible to know the length of the cluster from the start index ss₀ and the end index ee₀ of the cluster with 1=0, and the knowledge about the length of the cluster makes it possible to obtain unknown end indexes ee₁ and ee₂ from the known start indexes ss₁ and ss₂, only the start index is used. Thus, by obviating the transmission of end indexes for all but the first cluster, the resource allocation apparatus 1000 can reduce an information quantity of the transferred resource allocation information while transferring the resource allocation information.

Further, the resource allocation apparatus 1100 of FIG. 11 does not generate the resource allocation information by using both of the offset and the length of each cluster. Instead, as illustrated in FIG. 12, the resource allocation apparatus 1100 of FIG. 11 generates the resource allocation information by using both of the offset oo₀ and the length ww₀ only for the cluster with 1=0, and by using only the offset oo₁ and the offset oo₂ for the cluster with 1=1 and the cluster with 1=2, respectively. As described above, because it is possible to obtain unknown end indexes ee₁ and ee₂ from the known start indexes ss₁ and ss₂ recognizable from the offsets oo₁ and oo₂ based on the length ww₀ of the cluster with 1=0, only the offset is used. Therefore, the resource allocation apparatus 1100 of FIG. 11 can reduce the quantity of resource allocation information transferred while transferring the resource allocation information.

FIG. 13 is a flowchart illustrating a resource allocation method according to an exemplary embodiment of the invention. The resource allocation method of FIG. 13 may be performed by resource allocation apparatuses 1000 and 1100.

Referring to FIG. 13, the resource allocation method by the resource allocation apparatuses 1000 and 1100 includes a pre-processing step (S1300), an encoding step (S1302), and a transmission step (S1304).

In the pre-processing step S1300, cluster information for each of the one or more clusters including one or more RBs or RBGs is converted to one or more coefficients (a first coefficient and/or a second coefficient) used for the generation of the resource allocation information. In this case, because the lengths of all the clusters are the same, for the efficient generation of the resource allocation information the following procedure may be performed. Specifically, in the pre-processing step (S1300), with respect to at least one first cluster for the notification of the length of the cluster, the cluster information including both of the start index and the end index or the cluster information and including both of the offset and the length is converted to the two coefficients (i.e. the first coefficient sⁱⁿ₀ and the second coefficient sⁱⁿ₁). With respect to one or more remaining second clusters except for the first cluster for the purpose of the notification of the length of the cluster, the cluster information including only the start index or the end index or the cluster information including only the offset is converted to a single coefficient (the first coefficient or the second coefficient).

In the encoding step S1302, when the lengths of the one or more clusters including the one or more RBs or RBGs are the same, the encoded resource allocation information is generated by using the first coefficient and the second coefficient converted from the cluster information to include both of the start index and the end index or from the cluster information and including both of the offset and the length for only at least one first cluster among all the clusters, and by using the first coefficient or the second coefficient converted from the cluster information including either the start index or end index or the cluster information including the offset of the one or more remaining second clusters.

In the transmission step S1304, the resource allocation information generated in the encoding step S1302 is transmitted to the UE 10.

According to the above description, the resource allocation method generates the resource allocation information of a smaller bit quantity by encoding the simplified cluster information, instead of using all cluster information (both of the start index and the end index, or both of the offset and the length) for all the clusters.

Hereinafter, an embodiment of the resource allocation reception apparatus 220 shown in FIG. 2, i.e. resource allocation reception apparatuses 1400 and 1600 and a resource allocation method by the resource allocation reception apparatuses 1400 and 1600 will be described with reference to FIG. 14, FIG. 15, FIG. 16, and FIG. 17.

FIG. 14 is a diagram illustrating a resource allocation reception apparatus according to an exemplary embodiment of the invention. The resource allocation reception apparatus 1400 is an embodiment of the resource allocation reception apparatus 220 illustrated in FIG. 2.

As illustrated in FIG. 14, the resource allocation reception apparatus 1400 includes a receiver 1410, a decoder 1420, and a post-processor 1430.

The resource allocation reception apparatus 1400 is a resource allocation reception apparatus which may be used to receive the resource allocation information from the resource allocation apparatus 400 of FIG. 4 or the resource allocation apparatus 700 of FIG. 7. Therefore, the resource allocation reception apparatus 1400 includes the receiver 1410, the decoder 1420, and the post-processor 1430, which correspond to the pre-processor 410, the encoder 420, and the transmitter 430 of the resource allocation apparatus 400 of FIG. 4, and the pre-processor 710, the encoder 720, and the transmitter 730 of the resource allocation apparatus 700 of FIG. 7.

Referring to FIG. 14, the receiver 1410 receives the resource allocation information (r) which is encoded from information for the resource allocation for one or more clusters. The decoder 1420 decodes the resource allocation information (r) and extracts coefficients for recognizing the start index and the end index for each cluster. The post-processor 1430 converts the first coefficient and the second coefficient of each cluster obtained from the coefficients extracted from the decoder 1420 to the start index and the end index, respectively. Through this, the resource allocation reception apparatus 1400 can decipher the RB or RBGs to which the resource has been allocated.

The decoder 1420 decodes the resource allocation information encoded by the encoding in the encoder 420 of the resource allocation apparatus 400 of FIG. 4 or the encoding (Equation (3)) in the encoder 720 of the resource allocation apparatus 700 of FIG. 7.

A method for decoding the resource allocation information (r) by the decoder 1420 is described below. The decoder 1420 increases a variable (x) by a predetermined value (e.g. 1) until a combination value

$$( ( \begin{matrix}{N}^{in} - x \\ {M}^{in} - k\end{matrix} ) ) ,$$

which is a value (Nⁱⁿ−x) obtained by subtracting the variable x from Nⁱⁿ taken in combination with the value of (Mⁱⁿ−k) obtained by subtracting a coefficient index k(0≦k≦Mⁱⁿ−1) from the total number Mⁱⁿ (Mⁱⁿ=2·L), becomes equal to or less than the resource allocation information (r). The variable (x) if the combination value is equal to or less than the resource allocation information (r) is determined as the coefficient s^{out}ₖ. A value obtained by subtracting the combination value from the resource allocation information (r) is stored again as the resource allocation information (r), and then the above processes are repeated for a next coefficient index (k). By the steps described above, all of the coefficients are extracted from the received resource allocation information (r). This encoding process may be expressed by the iterative process as shown below:

```
                  xₘᵢₙ = 1
                  for k = 0 to Mⁱⁿ − 1
                        x = xₘᵢₙ
                        $p = ( \begin{matrix}{N}^{in} - x \\ {M}^{in} - k\end{matrix} )$
                        while p > r
                              x = x + 1
                              $p = ( \begin{matrix}{N}^{in} - x \\ {M}^{in} - k\end{matrix} )$
                        end
                        s^{out}ₖ = x
                        xₘᵢₙ = s^{out}ₖ + 1
                        r = r − p
                  end
```

When the decoder 1420 extracts the coefficients for the recognition of the start index and the end index of each cluster, the post-processor 1430 classifies the extracted coefficients as the first coefficient and the second coefficient for each cluster, and then converts the classified first coefficient and classified second coefficient of each cluster to the start index and the end index, respectively, thus recognizing the start index and the end index.

In considering the various pre-processing techniques described above (i.e. when the start index is converted to the first coefficient by substituting with the first coefficient and the end index is converted to the second coefficient by adding the constant to the end index, or in which the start index is converted to the first coefficient by subtracting the constant from the start index and the end index is converted to the second coefficient by substituting the end index with the second coefficient) of the pre-processor 410 of the resource allocation apparatus 400 of FIG. 4 or the pre-processor 710 of the resource allocation apparatus 700 of FIG. 7, the post-processor 1430 of the resource allocation reception apparatus 1400 of FIG. 14 may perform the following post-processing process.

The post-processor 1330 may convert the first coefficient s^{out}₂ₗ to the start index ss₁ by substituting the first coefficient s^{out}₂ₗ with the start index ss₁ and convert the second coefficient s^{out}₂ₗ₊₁ to the end index ee₁ by subtracting the constant from the second coefficient s^{out}₂ₗ₊₁ for each cluster, so that the end result corresponds to the pre-processing scheme in which the start index ss₁ is converted to the first coefficient sⁱⁿ₂ₗ=ss₁ by substituting the start index ss₁ with the first coefficient sⁱⁿ₂ₗ=ss₁ and the end index ee₁ is converted to the second coefficient sⁱⁿ₂ₗ₊₁=ee₁+1 by adding the constant to the end index ee₁ in the pre-processing scheme of the pre-processors 410 and 710. The post-processing may be expressed by Equation (6) (which corresponds to Equation (1)) below.

ssₗ=s₂ₗ^{out}

eeₗ=s₂ₗ₊₁^{out}−1

N=N^{out}−1,

L=M^{out}/2 Equation (6)

In an embodiment, the post-processor 1430 may convert the first coefficient s^{out}₂ₗ to the start index ss₁ by adding a constant to the first coefficient s^{out}₂ₗ and convert the second coefficient s^{out}₂ₗ₊₁ to the end index ee₁ by substituting the second coefficient s^{out}₂ₗ₊₁ with the end index ee₁ for each cluster, so that it corresponds to the pre-processing described above (i.e. in which the start index ss₁ is converted to the first coefficient sⁱⁿ₂ₗ=ss₁−1 by subtracting the constant from the start index ss₁, and the end index is converted to the second coefficient sⁱⁿ₂ₗ₊₁=ee₁ by substituting the end index ee₁ with the second coefficient sⁱⁿ₂ₗ₊₁=ee₁ in the pre-processing scheme of the pre-processors 410 and 710). This post-processing is shown below with equation 7:

ssₗ=s₂ₗ^{out}+1

eeₗ=s₂ₗ₊₁^{out}

N=N^{out}−1,

L=M^{out}/2 Equation (7)

The start index ss₁ and the end index ee₁ for each cluster converted by the aforementioned scheme may be converted to the offset oo₁ and the length ww₁ of each cluster by using Equation (4).

FIG. 15 is a flowchart illustrating a resource allocation reception method according to an exemplary embodiment of the invention. The resource allocation reception method of FIG. 15 may be performed by user equipment (such as UE 10) provided by the resource allocation reception apparatus 1400.

Referring to FIG. 15, the resource allocation reception method for user equipment provided by the resource allocation reception apparatus 1400 includes a reception step (S1500) for receiving the resource allocation information which is previously encoded from the information on the resource allocation based on one or more clusters, a decoding step (S1502) for decoding the resource allocation information and extracting coefficients for recognition of the start index and the end index for each cluster, and a post-processing step (S1504) for converting the first coefficient and the second coefficient of each cluster obtained from the extracted coefficients to the start index and the end index, respectively.

The decoding step S1502 and the post-processing step S1504 may be performed by the decoder 1420 and the post-processor 1430 of FIG. 14, respectively.

FIG. 16 is a diagram illustrating a resource allocation reception apparatus according to an exemplary embodiment of the invention. The resource allocation reception apparatus 1600 shown in FIG. 16 corresponds to an embodiment of resource the allocation reception apparatus 220 shown in FIG. 2.

As illustrated in FIG. 16, the resource allocation reception apparatus 1600 includes a receiver 1610, a decoder 1620, and a post-processor 1630. The resource allocation reception apparatus 1600 is a resource allocation reception apparatus corresponding to the resource allocation apparatuses 1000 and 110 of FIG. 10 and FIG. 11 performing the resource allocation based on the assumption that the lengths of all the clusters are the same.

Referring to FIG. 16, the receiver 1610 receives the resource allocation information (r) which is encoded from the information on the resource allocation to one or more clusters. The decoder 1620 then decodes the resource allocation information. After which, the post-processor 1630 recognizes the start index and the end index, or the offset and the length of every cluster included in the resource allocation information from the decoded result of the resource allocation information.

A decoded result 1621 of the resource allocation information in the decoder 1620, does not include the cluster information including both of the start index and the end index of each cluster or the cluster information including both of the offset and the length of the cluster for each of all the clusters, but includes the cluster information including both of the start index and the end index of each cluster or the cluster information including both of the offset and the length of the cluster only for at least one cluster (i.e. the first cluster). Further, the decoded result 1621 of the resource allocation information in the decoder 1620 may include only one of the start index and the end index, or only the offset for the remaining cluster or clusters (i.e. the second cluster or clusters) except for the first cluster. The decoder 1620 performs the decoding process the same as that performed in the decoder 1420 of FIG. 14.

The post-processor 1630 extracts the cluster information including both the start index and the end index or the cluster information including both the offset and the length of the cluster of at least the first cluster (which is the cluster used to derive the length of the cluster) and the cluster information including either start index or end index, or the cluster information including only the offset of each of one or more of the remaining clusters (which are the clusters not to derive the length of the cluster) from the decoded result 1621 of the resource allocation information. Through this, the post-processor 1630 derives the length of the cluster from the start index and the end index included in the extracted cluster information for the first cluster or identifies the length of the cluster included in the extracted cluster information (the cluster information including the offset and the length of the cluster) for the first cluster, and recognizes a non-extracted end index or start index of each second cluster based on the derived or identified length of the cluster. Based on the assumption and situation that the lengths of the clusters are the same, the post-processor 1630 recognizes the length of the cluster from the cluster information (including both of the start index and the end index or both of the offset and the length) of the first cluster used for the identification of the length of the cluster from the decoded result of the resource allocation information and recognizes the unknown index (the start index or the end index) for the remaining cluster or clusters based on the recognized length of the cluster. Through the above described operation of the post-processor, it is possible to derive cluster information 1631 that includes both of the start index and the end index of each of all the clusters. Through the cluster information 1631, it is possible to determine which resource has been allocated to the cluster by the resource allocation apparatus 1000.

In the meantime, if the resource allocation apparatus of FIG. 10 corresponding to the resource allocation reception apparatus 1600 FIG. 16 generates the resource allocation information through the pre-processing in which the start index and the end index are converted to the first coefficient and the second coefficient, respectively, it becomes possible to recognize the first coefficient and the second coefficient from the decoded result in the decoder 1620 of the resource allocation reception apparatus 1600 of FIG. 16. Therefore, the post-processor 1630 performs the post-processing of converting the first coefficient and the second coefficient to the start index and the end index, respectively, ultimately corresponding to the pre-processing of FIG. 10.

FIG. 17 is a flowchart illustrating a resource allocation reception method according to an exemplary embodiment of the invention. The resource allocation reception method of FIG. 17 may be performed by the UE using a resource allocation reception apparatus 1600.

Referring to FIG. 17, the resource allocation reception method includes a reception step (S1700), a decoding step (S1702), and a post-processing step (S1704).

In the reception step S1700, the resource allocation information (r), which is encoded from information for the resource allocation for one or more clusters, is received.

In the decoding step S1702, the resource allocation information, in which the information on the resource allocation to one or more clusters is encoded, is decoded.

In the post-processing step S1704, the length of the cluster is identified from the decoded result of the resource allocation information, which is then subsequently used to determine the start index and the end index of every cluster included in the resource allocation information.

Specifically, in the post-processing step S1704, the cluster information including both of the start index and the end index or the cluster information including both of the offset and the cluster of at least the first cluster (which is the cluster used for the recognition of the length of the cluster), and the cluster information including either start index or end index, or the cluster information including only the offset for each of one or more second clusters (which are the clusters not used for the recognition of the length of the cluster) from the decoded result of the resource allocation information. Through this, in the post-processing step S1704, by identifying the length of the cluster from the start index and the end index included in the extracted cluster information for the first cluster or the length of the cluster included in the extracted cluster information (the cluster information including the offset and the length of the cluster) for the first cluster, it is possible to recognize the non-extracted end index or start index of each second cluster based on the identified length of the cluster. In the post-processing step S1704, on the assumption that the lengths of the clusters are the same, the length of the cluster is derived from the cluster information (including both of the start index and the end index or both of the offset and the length) of the first cluster used for the identification of the length of the cluster from the decoded result of the resource allocation information and the unknown index (the start index or the end index) for the remaining second cluster or clusters is recognized based on the recognized length of the cluster. Through this, it is possible to recognize cluster information 1631 including both of the start index and the end index for each of the clusters. Based on the cluster information 1631, it becomes possible to determine which resource have been allocated to the cluster by the resource allocation apparatus 1000.

By using the aforementioned resource allocation methods, it becomes possible to reduce the bit quantity of the transmitted resource allocation information, and to achieve an efficient resource allocation in wireless communication systems.

Even if described in this disclosure that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as independent hardware, some or all of the components may be selectively combined with each other, so that they can be implemented as a computer program having one or more program modules for executing some or all of the functions combined in one or more hardware elements. Codes and code segments forming the computer program can be easily conceived by an ordinarily skilled person in the technical field of the present invention. Such a computer program may be implemented by the embodiments of the present invention by being stored in a non-transitory computer readable storage medium, and being read and executed by a computer. A magnetic recording medium, an optical recording medium, or the like may be employed as the storage medium.

In addition, since terms, such as “including,” “comprising,” and “having” mean that one or more corresponding components may exist unless they are specifically described to the contrary, it shall be construed that one or more other components may be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

While the exemplary embodiments have been shown and described, it will be understood by those skilled in the art that various changes in form and details may be made thereto without departing from the spirit and scope of this disclosure as defined by the appended claims and their equivalents. Thus, as long as modifications fall within the scope of the appended claims and their equivalents, they should not be misconstrued as a departure from the scope of the invention itself.

What is claimed is:

1. A base station, comprising:
an encoder to generate single resource allocation information (r) by encoding a first coefficient sⁱⁿₖ (wherein, k=2*1, and 1 is an integer) and a second coefficient sⁱⁿₖ (wherein, k=2*1+1, and 1 is an integer),
the first coefficient being obtained by converting a start index of one or more clusters including one or more resource blocks or resource block groups,
the second coefficient sink being obtained by converting an end index of the one or more clusters; and
a transmitter to transmit the resource allocation information (r) to a user equipment,
wherein the resource allocation information is generated by the encoder using
$$r = {\sum }_{k = 0}^{{M}^{in} - 1} 〈 \begin{matrix}{N}^{in} - {S}_{k}^{in} \\ {M}^{in} - k\end{matrix} 〉 , \\ 〈 \begin{matrix}x \\ y\end{matrix} 〉 = \{ \begin{matrix}( \begin{matrix}x \\ y\end{matrix} ) & x \geq y \\ 0 & x < y ,\end{matrix} \\ and \\ ( \begin{matrix}x \\ y\end{matrix} ) {=}_{x} {C}_{y}$$
wherein Nⁱⁿ is a total number of resource blocks or resource block groups+1, and Mⁱⁿ is a total number of coefficients, and C is a combination of x into y,
wherein the first coefficient for each cluster is the start index of each cluster and the second coefficient for each cluster is a value obtained by adding a constant 1 to the end index of is each cluster.

2. The base station as claimed in claim 1, wherein the resource blocks or the resource block groups are communicated in an uplink.

3. A resource allocation apparatus, comprising:
an encoder to generate single resource allocation information (r) by encoding a first coefficient sⁱⁿₖ (wherein, k=2*1, and 1 is a integer) and a second coefficient sⁱⁿₖ (wherein, k=2*1+1, and 1 is an integer),
the first coefficient being obtained by converting a start index of one or more clusters including one or more resource blocks or resource block groups,
the second coefficient being obtained by converting an end index of the one or more clusters; and
a transmitter to transmit the resource allocation information (r) to a user equipment,
wherein the resource allocation information is generated by the encoder using
$$r = {\sum }_{k = 0}^{{M}^{in} - 1} 〈 \begin{matrix}{N}^{in} - {S}_{k}^{in} \\ {M}^{in} - k\end{matrix} 〉 , \\ 〈 \begin{matrix}x \\ y\end{matrix} 〉 = \{ \begin{matrix}( \begin{matrix}x \\ y\end{matrix} ) & x \geq y \\ 0 & x < y ,\end{matrix} \\ and \\ ( \begin{matrix}x \\ y\end{matrix} ) {=}_{x} {C}_{y}$$
wherein Nⁱⁿ is a total number of resource blocks or resource block groups+1, and Mⁱⁿ is a total number of coefficients, and C is a combination of x into y,
wherein the first coefficient for each cluster is the start index of each cluster and the second coefficient for each cluster is a value obtained by adding a constant 1 to the end index of each cluster.

4. The resource allocation apparatus as claimed in claim 3, wherein the resource blocks or the resource block groups are communicated in an uplink.

5. A method for resource allocation, comprising:
generating single resource allocation information (r) by encoding a first coefficient sⁱⁿₖ (wherein, k=2*1, and 1 is an integer) and a second coefficient sⁱⁿₖ (wherein, k=2*1+1, and 1 is a integer), the first coefficient being obtained by converting a start index of one or more clusters s including one or more resource blocks or resource block groups, the second efficient being obtained by converting an end index of the one or more clusters; and
transmitting the resource allocation information (r) to a user equipment,
wherein the resource allocation information is generated by using
$$r = {\sum }_{k = 0}^{{M}^{in} - 1} 〈 \begin{matrix}{N}^{in} - {S}_{k}^{in} \\ {M}^{in} - k\end{matrix} 〉 , \\ 〈 \begin{matrix}x \\ y\end{matrix} 〉 = \{ \begin{matrix}( \begin{matrix}x \\ y\end{matrix} ) & x \geq y \\ 0 & x < y ,\end{matrix} \\ and \\ ( \begin{matrix}x \\ y\end{matrix} ) {=}_{x} {C}_{y}$$
wherein Nⁱⁿ is a total number of resource blocks or resource block groups+1, and Mⁱⁿ is a total number of coefficients, and C is a combination of x into y,
wherein the first coefficient for each cluster is the start index of each cluster and the second coefficient for each cluster is a value obtained by adding a constant 1 to the end index of each cluster.

6. The method as claimed in claim 5, wherein the resource blocks or the resource block groups are communicated in an uplink.

7. A user equipment, comprising:
a receiver to receive resource allocation information encoded from information on resources allocated to one or more cluster from a base station;
a decoder to decode the resource allocation information and to extract a first coefficient and a second coefficient for each cluster; and
a post-processor to convert the first coefficient and the second coefficient for each cluster to a start index and an end index of each cluster, respectively,
wherein the post-processor converts the first coefficient for the each cluster to the start index of the first cluster by substituting the first coefficient with the start index, and converts the second coefficient for the first cluster to the end index of the first cluster by subtracting a constant 1 from the second coefficient.

8. The user equipment as claimed in claim 7, wherein the each cluster comprises a resource block or a resource block group of resources used in an uplink.

9. A resource allocation reception apparatus, comprising:
a receiver to receive resource allocation information encoded from information on resources allocated to one or more cluster from a base station;
a decoder to decode the resource allocation information and to extract a first coefficient and a second coefficient for each cluster; and
a post-processor to convert the first coefficient and the second coefficient for the first cluster to a start index and an end index of each cluster, respectively,
wherein the post-processor converts the first coefficient for each cluster to the start index of each cluster by substituting the first coefficient with the start index, and converts the second coefficient for each cluster to the end index of each cluster by subtracting a constant 1 from the second coefficient.

10. The resource allocation reception apparatus as claimed in claim 9, wherein each cluster comprises a resource block or a resource block group of resources used in an uplink.

11. A method for resource allocation reception, comprising:
receiving resource allocation information encoded from information on resources allocated to one or more cluster from a base station;
decoding the resource allocation information and extracting a first coefficient and a second coefficient for each cluster; and
converting the first coefficient and the second coefficient for each cluster to a start index and an end index of each cluster, respectively,
wherein the post-processing comprises:
converting the first coefficient for each cluster to the start index of each cluster by substituting the first coefficient with the start index; and
converting the second coefficient for each cluster to the end index of each cluster by subtracting a constant 1 from the second coefficient.

12. The method as claimed in claim 11, wherein the each cluster comprises a resource block or a resource block group of resources used in an uplink.

13. A base station comprising:
an encoder to generate single resource allocation information (r) by encoding a first coefficient sⁱⁿₖ (wherein, k=21, and 1 is an integer) and a second coefficient sⁱⁿₖ (wherein, k=21+1, and 1 is a integer), the first coefficient being determined by converting a start index of each of one or more clusters including one or more resource blocks or resource block groups, the second coefficient sⁱⁿₖ being determined by converting an end index of each of one or more clusters; and
a transmitter to transmit the resource allocation information (r) to a user equipment,
wherein the resource allocation information is generated by using
$$r = {\sum }_{k = 0}^{{M}^{in} - 1} 〈 \begin{matrix}{N}^{in} - {S}_{k}^{in} \\ {M}^{in} - k\end{matrix} 〉 , \\ 〈 \begin{matrix}x \\ y\end{matrix} 〉 = \{ \begin{matrix}( \begin{matrix}x \\ y\end{matrix} ) & x \geq y \\ 0 & x < y ,\end{matrix} \\ and \\ ( \begin{matrix}x \\ y\end{matrix} ) {=}_{x} {C}_{y}$$
Nⁱⁿ is a total number of resource blocks or resource block groups+1, and Mⁱⁿ is a total number of coefficients,
wherein the end index is determined by subtracting a constant 1 from the second coefficient.
